(19) United States
(12) Patent Application Publication
(10) Pub. No.: US 2016/0069452 A1
(43) Pub. Date: Mar. 10, 2016

(54) ACTIVE ELECTROMECHANICAL ARMATURE ASSEMBLY FOR AN AUTOMATIC TRANSMISSION

(71) Applicant: GM Global Technology Operations LLC, Detroit, MI (US)

(72) Inventors: THOMAS R. MARTIN, ROYAL OAK, MI (US); CHRISTOPHER G. BENSON, ROCHESTER HILLS, MI (US); WAYNE B. VOGEL, CANTON, MI (US)

(21) Appl. No.: 14/799,213

(22) Filed: Jul. 14, 2015

Related U.S. Application Data
(60) Provisional application No. 62/045,928, filed on Sep. 4, 2014.

(51) Int. Cl. F16H 61/02; F16K 31/06

(52) U.S. Cl. CPC F16H 61/0276; F16K 31/0655; F16H 2061/0279

(57) ABSTRACT

An active electromechanical armature assembly for a transmission is provided. The active electromechanical armature assembly improves fuel economy by storing transmission fluid in areas away from rotating components during hot operation. During other conditions the transmission fluid is kept in the sump. The active electromechanical armature assembly includes a moveable armature or plunger. Movement of the plunger controls the opening and closing of an opening that communicates between the sump and the side or front cover of the transmission.

### CROSS-REFERENCE TO RELATED APPLICATIONS

This application claims the benefit of U.S. Provisional Application No. 62/045,928 filed Sep. 4, 2014. The disclosure of the above application is incorporated herein by reference.

### TECHNICAL FIELD

The invention relates to an active electromechanical hydraulic fluid level control system for an automatic transmission, and more particularly to an assembly for actively controlling hydraulic fluid level between a sump and a side or front cover in an automatic transmission using an electromechanical device.

### BACKGROUND

A typical automatic transmission includes a hydraulic control system that is employed to provide cooling and lubrication to components within the transmission and to actuate a plurality of torque transmitting devices such as clutches and brakes. The hydraulic control system typically includes a sump located at a bottom of the transmission that collects the hydraulic fluid from the remainder of the hydraulic control system. The sump stores the hydraulic fluid to be suctioned back into the hydraulic control system by a pump. A minimum level of hydraulic fluid is required in the sump in order to feed the hydraulic control system for all ranges of transmission operation and to account for dynamic movement of the hydraulic fluid within the sump. It is desirable to keep the amount of hydraulic stored in the sump to this minimum level since hydraulic fluid in the sump interferes with the rotating components of the transmission. The rotating components, including for example gears, clutch plates, and interconnecting members, traveling through the stored hydraulic fluid within the sump experience increased drag, thus increasing spin losses and in turn decreasing the efficiency of the transmission.

The minimum level of hydraulic fluid that must be stored in the sump varies based on various factors including the operating temperature of the hydraulic fluid. Therefore it is desirable to store excess hydraulic fluid out of the sump and in a separate area that does not interfere with rotating components. One solution is to actively control the level of hydraulic fluid between the sump and a front or side cover of the transmission using a passive thermal valve. These passive thermal valves allow hydraulic fluid to flow between the sump and the front cover based on the temperature of the hydraulic fluid. While these systems are useful for their intended purpose, there is a need in the art for an active control system that minimizes cost and mass and that allows excess hydraulic fluid to be stored out of the sump during normal operating conditions but not during certain other conditions, such as end-of-line testing or transportation of the transmission.

### SUMMARY

An active electromechanical armature assembly for a transmission is provided. The active electromechanical armature assembly improves fuel economy by storing transmission fluid in areas away from rotating components during hot operation. However, during other conditions the transmission fluid is kept in the sump. The active electromechanical armature assembly is a device which converts electrical energy into mechanical movement of an armature or plunger. Movement of the plunger seals and unseals an opening that communicates between the sump and the side or front cover of the transmission. The present invention improves fuel economy by as much as 0.5% by storing excess hydraulic fluid away from rotating components.

In one example, an assembly for use in a transmission of a motor vehicle includes a first fluid reservoir, a second fluid reservoir having a hole that communicates with the first fluid reservoir; and an electromechanical assembly disposed in the second fluid reservoir. The electromechanical assembly includes a coil, an armature disposed within the coil and moveable between a first position and a second position, and a plunger head connected to an end of the armature for sealing the hole between the first and second fluid reservoirs when the armature is in the first position.

In another example, the first fluid reservoir is located in a sump of the transmission and the second fluid reservoir is located in a side cover of the transmission.

In another example, the control valve further includes a biasing member that biases the armature to the second position.

In another example, the control valve further includes a coil housing connected to an end cap, and the coil is disposed within the coil housing and the armature extends out from the end cap.

In another example, the coil is disposed around an inner sleeve and the armature is slidable within the inner sleeve.

In another example, the coil is interconnected to an electronic control module.

In another example, the armature includes a base portion slidably disposed within the inner sleeve and a neck portion connected to the plunger head, and the neck portion is extended out from a bore in the end cap.

In another example, the plunger head includes an angled front surface that complements an angled surface surrounding the hole.

In another example, the biasing member is disposed partially within the inner sleeve and partially within an enlarged section of the bore of the end cap.

In another example, the biasing member is disposed around the neck portion of the armature and is in contact with an inner surface of the end cap and with the end surface of the base portion of the armature.

In another example, the first reservoir is separated from the second reservoir by a separator wall, and the hole is disposed through the separator wall.

In another example, the control valve is connected to the separator wall.

In another example, the second reservoir is disposed in a bottom portion of a side cover of the transmission.

In another example, the second reservoir is not in direct communication with rotating components of the transmission.

Further features and advantages of the present invention will become apparent by reference to the following description and appended drawings wherein like reference numbers refer to the same component, element or feature.

### BRIEF DESCRIPTION OF THE DRAWINGS

The drawings described herein are for illustration purposes only and are not intended to limit the scope of the present disclosure in any way.

FIG. 1 is a schematic diagram of an exemplary front wheel drive transmission according to the principles of the present invention;

FIG. 2 is an enlarged cross section of a portion of the exemplary front wheel drive transmission shown in FIG. 1;

FIG. 3 is a front or side view of the exemplary front wheel drive transmission of FIG. 1 with a side or front cover removed;

FIG. 4 is a side view of an electromechanical armature assembly used in the exemplary front wheel drive transmission according to the principles of the present invention;

FIG. 5A is a cross-sectional view taken in the direction of arrows 5-5 in FIG. 4 of the electromechanical armature assembly in a first position; and

FIG. 5B is a cross-sectional view taken in the direction of arrows 5-5 in FIG. 4 of the electromechanical armature assembly in a second position.

### DESCRIPTION

The following description is merely exemplary in nature and is not intended to limit the present disclosure, application, or uses.

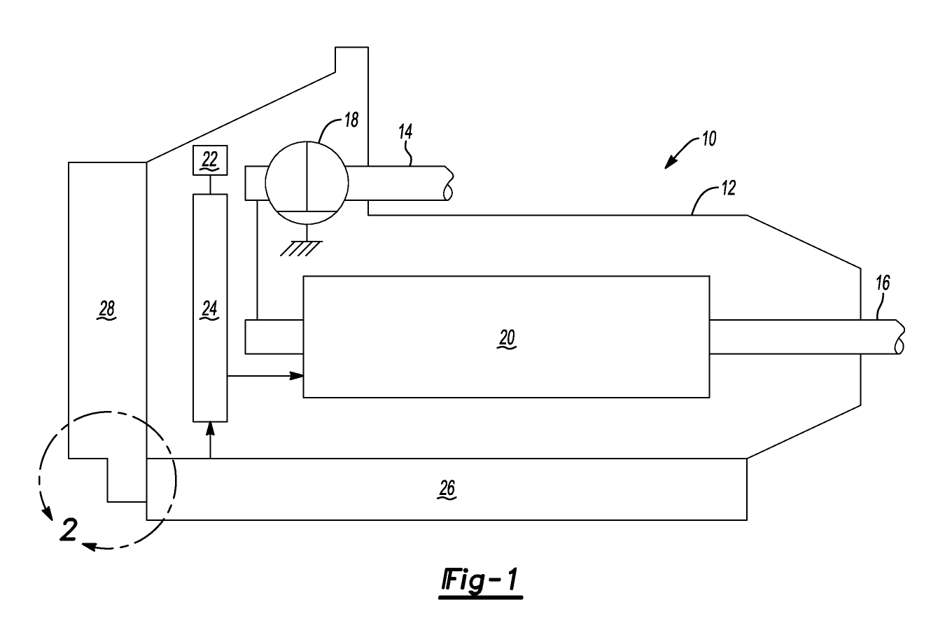

With reference to FIG. 1, a schematic diagram of an exemplary transmission is generally indicated by reference number 10. The transmission 10 is an automatic, front wheel drive, multiple speed transmission. However it should be appreciated that the transmission may be a manual transmission or any other type of transmission without departing from the scope of the present invention. The transmission 10 includes a typically cast, metal housing 12 which encloses and protects the various components of the transmission 10. The housing 12 includes a variety of apertures, passageways, shoulders and flanges which position and support these components. The transmission generally 10 includes an input shaft 14, an output shaft 16, a starting device 18, and a gear arrangement 20. The input shaft 14 is connected with a prime mover (not shown) such as an engine. The prime mover may be an internal combustion gas or Diesel engine or a hybrid power plant. The input shaft 14 receives input torque or power from the prime mover. The output shaft 16 is preferably connected with a final drive unit (not shown) which may include, for example, propshafts, differential assemblies, and drive axles. The input shaft 14 is coupled to and drives the gear arrangement 20 through the starting device 18. The starting device 18 is illustrated as a torque converter in the example provided, though various other hydrodynamic and mechanical devices may be used without departing from the scope of the present invention.

The gear arrangement 20 generally provides multiple forward and reverse speed or gear ratios between the input shaft 14 and the output shaft 16. The gear arrangement 20 may have various forms and configurations but generally includes a plurality of gear sets or a continuously variable unit having a chain or belt and movable pulley pairs, a plurality of shafts or interconnecting members, and at least one torque transmitting mechanism. The gear sets may include intermeshing gear pairs, planetary gear sets, or any other type of gear set. The plurality of shafts may include layshafts, countershafts, sleeve or center shafts, reverse or idle shafts, or combinations thereof. The torque transmitting mechanisms may include clutches, brakes, synchronizer assemblies or dog clutches, or combinations thereof, without departing from the scope of the present invention.

Operation of the starting device 18 and gear arrangement 20, including selection of gear ratios via clutch and brake engagement, is controlled by an electronic transmission control module (ETCM) 22 and a hydraulic control system 24. The ETCM 22 is preferably an electronic control device having a preprogrammed digital computer or processor, control logic, memory used to store data, and at least one I/O peripheral. The control logic includes a plurality of logic routines for monitoring, manipulating, and generating data. The ETCM 22 controls the actuation of the torque transmitting mechanisms in the gear arrangement 20 via the hydraulic control system 24. The hydraulic control system 24 generally includes electrically controlled solenoids and valves that selectively communicate hydraulic fluid throughout the transmission 10 in order to control, lubricate, and cool the various components of the transmission 10.

The hydraulic fluid used by the hydraulic control system 24 is primarily stored in a sump or reservoir 26. The sump 26 is preferably located at a bottom of the transmission 10. A pump (not shown) produces a suction that draws the hydraulic fluid from the sump 26 and into the hydraulic control system 24 where the hydraulic fluid is used to engage torque transmitting mechanisms and to cool and lubricate the transmission 10.

The transmission 10 further includes a front or side cover 28 attached to a side or front of the transmission 10. The side cover 28 protects components of the hydraulic control system 24 within the transmission 10 and functions as a secondary transmission oil storage reservoir, as will be described in greater detail below.

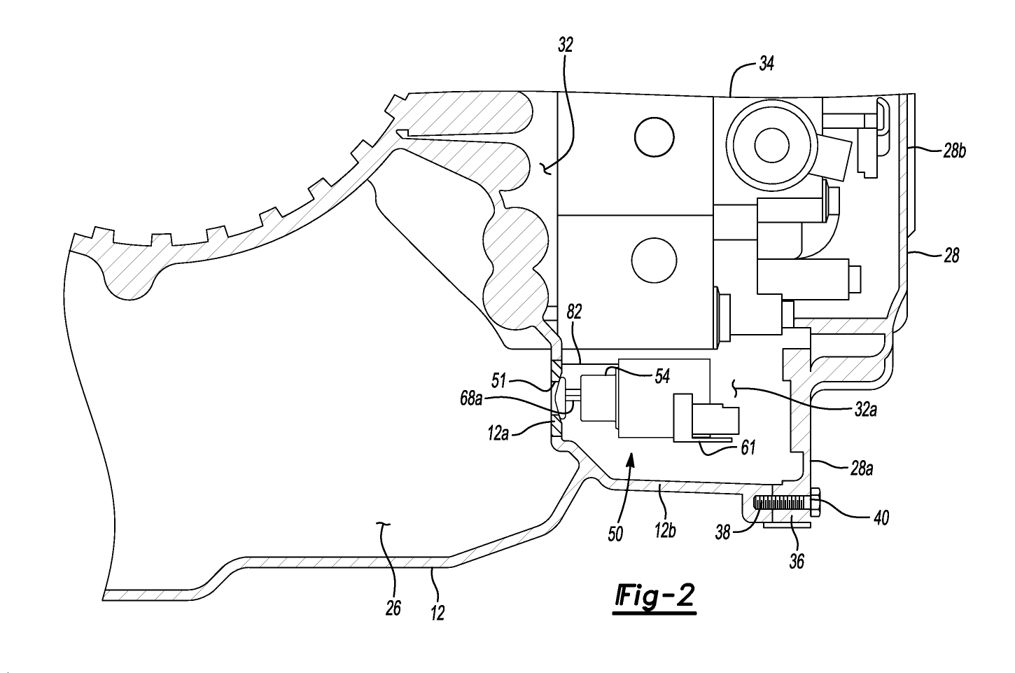

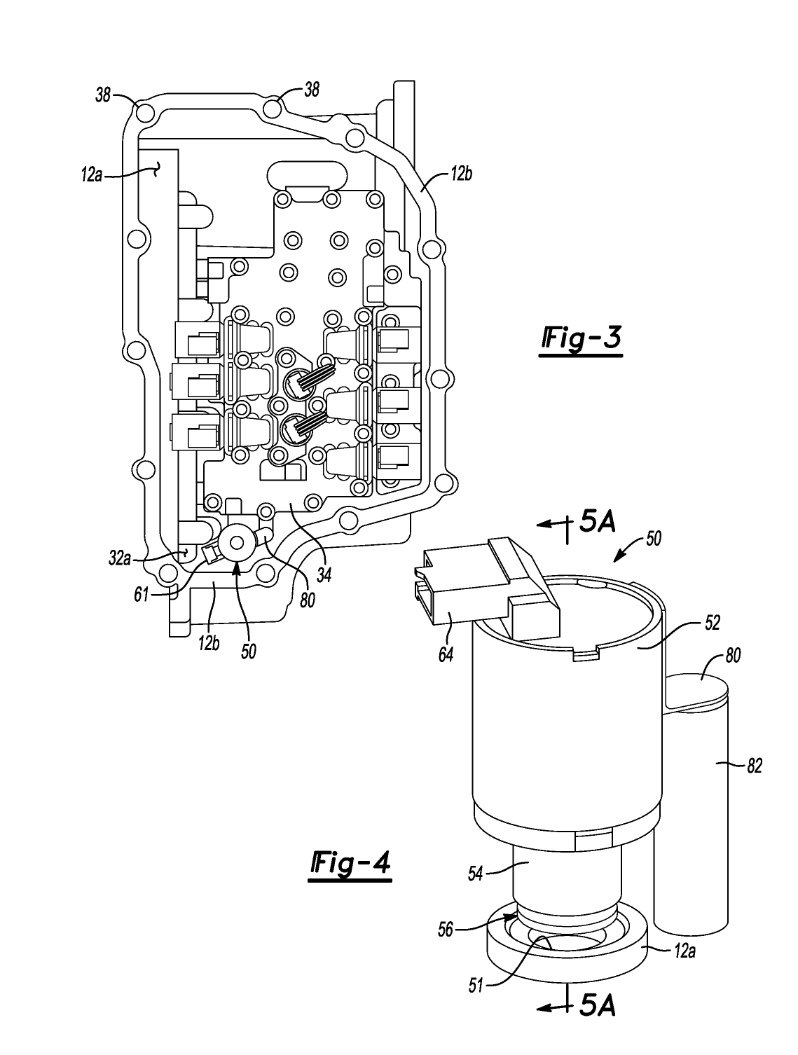

Turning to FIGS. 2 and 3, the transmission housing 12 includes a separator wall 12a that extends vertically from a bottom of the housing 12 to a top of the housing 12. A rim or flange 12b extends perpendicularly out from the separator wall 12a. The flange 12b is disposed around the entire outer periphery of the separator wall 12a, forming a pocket or cavity 32. Various components of the transmission 10 are disposed within the cavity 32, for example a transmission valve body 34 of the hydraulic control system 24. The transmission valve body 34 contains many of the pressure regulation valves, directional valves and solenoids that control the transmission 10.

The side cover 28 is configured to connect and seal to the flange 12b, thus enclosing the cavity 32. For example, the side cover 28 includes a wall or rim 28a that extends perpendicularly out from a main portion 28b. The rim 28a is disposed around the entire outer periphery of the side cover 28. The rim 28a includes a plurality of bolt holes 36 that align with a plurality of bolt holes 38 formed on the flange 12b. A plurality of bolts 40 or other fasteners connect the side cover 28 to the housing 12 overtop the cavity 32. A seal (not shown) is disposed on or radially inward of the rim 28a in order to seal the side cover 28 to the flange 12b of the housing 12.

A lower portion or secondary reservoir 32a of the cavity 32 acts as a secondary hydraulic fluid reservoir to the sump 26. The secondary reservoir 32a is not in communication with any rotating components of the transmission 10. Communication of the hydraulic fluid from the secondary reservoir 32a to the sump 26 is controlled via an active electromechanical armature assembly or control valve 50. The electromechanical armature assembly 50 is disposed within the secondary reservoir 32a of the cavity 32 near a bottom of the transmission housing 12. The electromechanical armature assembly 50 opens and closes a drain hole or sump drain-back 51 disposed in the separator wall 12a. The drain hole 51 allows fluid communication between the sump 26 and the secondary reservoir 32a.

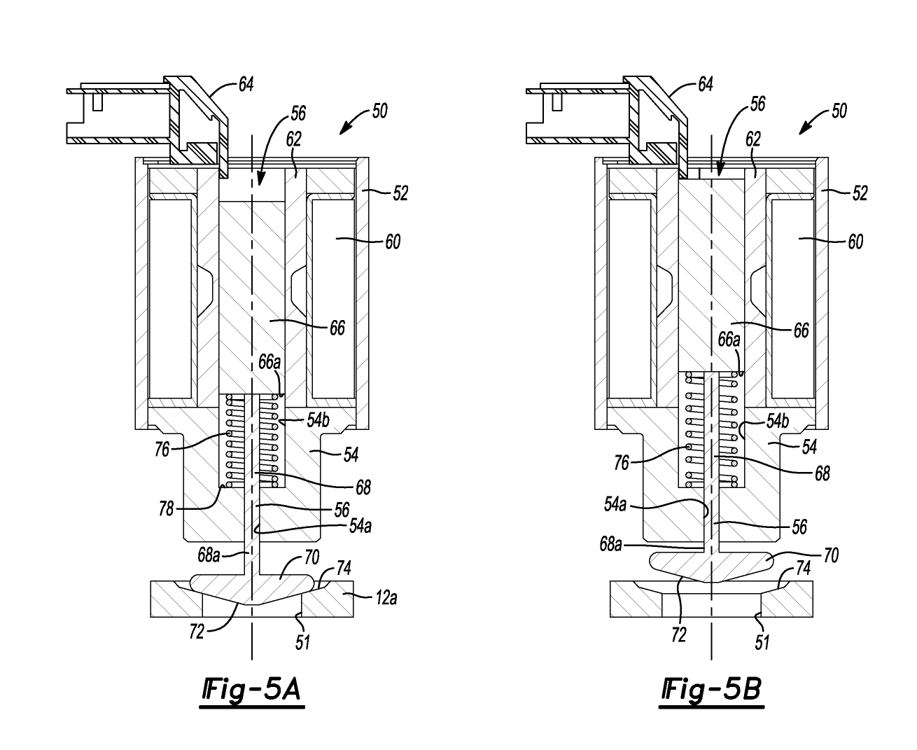

Turning to FIG. 4, the electromechanical armature assembly 50 generally includes a coil housing 52 connected to an end cap 54. A moveable plunger or armature 56 extends out from the end cap 54. The armature 56 is moveable between a first position, shown in FIG. 5A, and a second position shown in FIG. 5B. Movement of the armature 56 selectively seals the drain hole 51, as will be described in greater detail below.

With reference to FIGS. 5A and 5B and continued reference to FIG. 4, an electrical coil or other resistance element 60 is disposed about or wrapped around an inner sleeve 62 disposed within the coil housing 52. The coil 60 is connected to a connector port 64 disposed on an outside of the coil housing 52. The connector port 64 is interconnected to the ETCM 22 or to another power source. The coil 60 is enclosed and protected by the coil housing 52.

The armature 56 includes a base portion 66 slidably disposed within the inner sleeve 54. The base portion 66 is preferably made from steel, iron or another ferro-magnetic material. A neck portion 68 extends out from an end surface 66a of the base portion 66. The neck portion 68 is disposed through a bore 54a formed in the end cap 54. A distal or end portion 68a of the neck portion 68 terminates in a plunger head 70. The plunger head 70 is disposed outside the coil housing 52 and the end cap 54. The plunger head 70 has an angled front surface 72 that complements an angled surface 74 in the separating wall 12a surrounding the drain hole 51.

A biasing member 76, such as a spring, is disposed partially within the sleeve 62 and partially within an enlarged section 54b of the bore 54a of the end cap 54. It should be appreciated that other types of biasing members may be employed without departing form the scope of the present invention. In the example provided, the biasing member 76 is disposed around the neck portion 68 of the armature and is in contact with an inner surface 78 of the end cap 54 and with the end surface 66a of the base portion 66 of the armature 56. The biasing member 76 biases the armature 56 to the second (i.e. open) position. In the second position, shown in FIG. 5B, the plunger head 70 is not seated in the drain hole 51.

To move the armature to the first position (i.e. closed) position, the ETCM 22 commands an electric current through the coil 60. The electrical current flowing through the coil 60 generates a magnetic field, and the direction of this magnetic field with regards to its North and South Poles is determined by the direction of the current flow within the coil 60. The strength of this magnetic field can be increased or decreased by controlling the amount of current flowing through the coil 60. The armature 56 disposed within the coil 60 is attracted towards the center of the coil 60 by a magnetic flux. Thus the armature 56 moves or strokes within the inner sleeve 62 and compresses the biasing member 76 as the armature 56 moves towards the drain hole 51. When the armature 56 is fully extended and in the closed position, the angled front surface 72 fully contacts the angled surface 74 and seals the drain hole 51.

Returning to FIGS. 2 and 4, the electromechanical armature assembly 50 is connected to the separator wall 12a of the housing 12 by a bracket 80 and pin or case boss 82. The bracket 80 and case boss 82 position the electromechanical armature assembly 50 above the drain hole 51 within the secondary reservoir 32a at a predetermined, fixed height relative to the drain hole 51. Communication between the sump 26 and the secondary reservoir 32a is controlled by activation of the electromechanical armature assembly 50. For example, the fluid level in the sump may be kept reduced by storing fluid within the secondary reservoir 32a by commanding a current in the coil 60, thus creating a magnetic flux and moving the armature 56 against the biasing member 76 to seal the drain hole 51 with the plunger head 70. Closing of the electromechanical armature assembly 50 hydraulically isolates the secondary reservoir 32a from the sump 26 thereby keeping the fluid level within the sump 26 to a predefined minimum. This predefined minimum is controlled by a distance of the electromechanical armature assembly 50 from a bottom of the sump 26. When the transmission cools and the current in the coil 60 is reduced, the biasing member 76 moves the armature 56 to the open position, thus unsealing the drain hole 51. Transmission fluid can then communicate from the secondary reservoir 32a through the drain hole 51 and into the sump 26.

Keeping the level of hydraulic fluid in the sump 26 to a minimum enables components of the gear arrangement 20 such as planetary gear sets, shafts or members, and clutches or brakes to rotate with a minimum of spin losses. The result is a more efficient transmission providing improved fuel economy.

The description of the invention is merely exemplary in nature and variations that do not depart from the general essence of the invention are intended to be within the scope of the invention. Such variations are not to be regarded as a departure from the spirit and scope of the invention.

The following is claimed:

1. An assembly for use in a transmission of a motor vehicle, the assembly comprising:
a first fluid reservoir;
a second fluid reservoir having a hole that communicates with the first fluid reservoir; and
a control valve disposed in the second fluid reservoir having:
a coil;
an armature disposed within the coil and moveable between a first position and a second position; and
a plunger head connected to an end of the armature for sealing the hole between the first and second fluid reservoirs when the armature is in the first position.

2. The assembly of claim 1 wherein the first fluid reservoir is located in a sump of the transmission and the second fluid reservoir is located in a side cover of the transmission.

3. The assembly of claim 1 wherein the control valve further includes a biasing member that biases the armature to the second position.

4. The assembly of claim 3 wherein the control valve further includes a coil housing connected to an end cap, and wherein the coil is disposed within the coil housing and the armature extends out from the end cap.

5. The assembly of claim 4 wherein the coil is disposed around an inner sleeve and the armature is slidable within the inner sleeve.

6. The assembly of claim 5 wherein the coil is interconnected to an electronic control module.

7. The assembly of claim 6 wherein the armature includes a base portion slidably disposed within the inner sleeve and a neck portion connected to the plunger head, and the neck portion is extended out from a bore in the end cap.

8. The assembly of claim 7 wherein the plunger head includes an angled front surface that complements an angled surface surrounding the hole.

9. The assembly of claim 8 wherein the biasing member is disposed partially within the inner sleeve and partially within an enlarged section of the bore of the end cap.

10. The assembly of claim 9 wherein the biasing member is disposed around the neck portion of the armature and is in contact with an inner surface of the end cap and with the end surface of the base portion of the armature.

11. The assembly of claim 1 wherein the first reservoir is separated from the second reservoir by a separator wall, and the hole is disposed through the separator wall.

12. The assembly of claim 11 wherein the control valve is connected to the separator wall.

13. The assembly of claim 12 wherein the second reservoir is disposed in a bottom portion of a side cover of the transmission.

14. The assembly of claim 13 wherein the second reservoir is not in direct communication with rotating components of the transmission.

15. A transmission comprising:
a transmission housing that defines a sump;
a side cover connected to the transmission housing that defines a reservoir;
a drain hole disposed between the sump and the reservoir to communicate hydraulic fluid between the sump and the reservoir; and
an electromechanical armature assembly comprising:
an armature moveable between a first position and a second position; and
a plunger head connected to an end of the armature for sealing the drain hole between the sump and the reservoir when the armature is in the first position;
an actuator for moving the armature to the first position; and
a biasing member for biasing the armature to the second position.

16. The transmission of claim 15 wherein the armature is disposed within a housing and the plunger head is disposed outside of the housing.

17. The transmission of claim 15 wherein the actuator is controlled by a transmission control module.

18. The transmission of claim 15 wherein the sump is separated from the reservoir by a separator wall, and the drain hole is disposed through the separator wall and the electromechanical armature assembly is connected to the separator wall.

19. The transmission of claim 15 wherein the reservoir is disposed in a bottom portion of the side cover of the transmission.

20. The transmission of claim 15 wherein the sump is in hydraulic communication through the drain hole with the reservoir when the armature is in the second position.
